(19) United States
(12) Patent Application Publication
(10) Pub. No.: US 2012/0086274 A1
(43) Pub. Date: Apr. 12, 2012

(54) CIRCUIT SYSTEM HAVING STANDBY POWER SUPPLY UNIT AND CIRCUIT SYSTEM LAYOUT METHOD

(75) Inventors: SUNG-TA TSAI, Jiaoxi Township (TW); HUANG-CHIN CHANG, Zhonghe City (TW); CHING-FENG HSIEH, Taipei City (TW)

(73) Assignee: ASKEY COMPUTER CORP., Taipei (TW)

(21) Appl. No.: 12/954,959

(22) Filed: Nov. 29, 2010

(30) Foreign Application Priority Data
Oct. 12, 2010 (TW) 099134714

(51) Int. Cl. H02J 9/00; G06F 17/50

(52) U.S. Cl. 307/51; 716/139

(57) ABSTRACT

A circuit system layout method for laying out a circuit system has a standby power supply unit. The circuit system includes a core circuit set and a non-core circuit set and operates on power supplied by a power source. The core circuit set is still enabled to finalize a temporary process with the power supplied by the standby power supply unit upon an unexpected interruption of the power supplied by the power source. The core circuit set is connected to an energy storing element for storing and discharging the power, and connected to a one-way element for ensuring that the power stored in the energy storing element is supplied to the core circuit set only. The core circuit set performs the temporary process even when the power source does not enable the circuit system to operate. The circuit system is further provided.

### CROSS-REFERENCE TO RELATED APPLICATION

This non-provisional application claims priority under 35 U.S.C. §119(a) on Patent Application No(s). 099134714 filed in Taiwan, R.O.C. on Oct. 12, 2010, the entire contents of which are hereby incorporated by reference.

### FIELD OF THE TECHNOLOGY

The present invention relates to circuit systems having a standby power supply unit and the circuit system layout method, and more particularly, to a circuit system and the circuit system layout method for supplying the minimal standby power required for operation of a core circuit set in the circuit system when power supplied by a power source no longer enables operation of the circuit system.

### BACKGROUND

It is not uncommon for a conventional circuit system to break down and thereby cause the loss or damage of a process running in the circuit system following an unexpected interruption of power supplied by a power source.

To overcome the aforesaid drawback of the prior art, engineers came up with a method of storing power in advance. The method, which is configured for use with an uninterruptible power supply (UPS) system comprising a large power storage apparatus, involves supplying continuously, upon power interruption, power to a circuit system by the UPS system during the period of power interruption so as for a user to perform backup operation or storage operation on the circuit system during the period of power interruption. Although the UPS system prevents a process from being lost or damaged following an unexpected power supply interruption, the UPS system does have its own drawbacks, namely bulky, heavy, expensive, and not portable, not to mention that the UPS system cannot be effectively integrated into an existing circuit system.

Ensuing development of related technology was aimed at further overcoming the drawbacks of the UPS system. For instance, Taiwan Patent No. 1271993 was put forth to solve a known problem, that is, failure of an ADSL user-end apparatus to send a power interruption signal to a local-end apparatus, because the ADSL user-end apparatus is not operating due to power outage. Despite its success in solving the aforesaid problem, Taiwan Patent No. 1271993 proves unfit to address another issue—with the user-end apparatus relying upon one and only one power source, a capacitor for storing the power supplied by the power source can support the operation of the user-end apparatus only if the capacitor is of high capacitance.

Furthermore, to render an existing circuit system (e.g. mobile phone) portable, downsized electronic components are installed in the existing circuit system. As a result, despite the key role they play in handling power interruption, capacitors of high capacitance are not used in the existing circuit system.

### SUMMARY

It is a primary objective of the present invention to provide a circuit system having a standby power supply unit so as to supply the minimal standby power required for operation of a core circuit set of the circuit system when power supplied by a power source no longer enables operation of the circuit system.

Another objective of the present invention is to provide a circuit system layout method for enabling a core circuit set of a circuit system to execute a temporary process until completion thereof when power supplied by a power source no longer enables operation of the circuit system.

In order to achieve the above and other objectives, the present invention provides a circuit system having a standby power supply unit and operating on power supplied by a power source, the circuit system comprising: a core circuit set preloaded with a temporary process; a non-core circuit set connected to the power source for receiving the power; a standby power supply unit comprising a one-way element and an energy storing element, the one-way element having an input end for connection with the power source and an output end for connection with the core circuit set and the energy storing element, the one-way element preventing stored-power stored in the energy storing element from being fed back to the input end from the output end, and the energy storing element serving both a charging purpose and a discharging purpose; and an irregular power supply detecting unit connected to the core circuit set, configured to detect a supplying state of the power, and configured to send, upon detection of interruption of the power, a control signal to the core circuit set so as for the core circuit set to execute the temporary process.

In order to achieve the above and other objectives, the present invention further provides a circuit system layout method configured for use with a circuit system having a standby power supply unit and operating on power supplied by a power source, the circuit system layout method comprising the steps of: distinguishing between a core circuit set and a non-core circuit set in a circuit set, wherein the core circuit set is preloaded with a temporary process; connecting the non-core circuit set to the power source for receiving the power therefrom; connecting the core circuit set and an energy storing element to an output end of a one-way element, wherein the energy storing element and the one-way element collectively function as the standby power supply unit, and an input end of the one-way element connects with the power source and prevents stored-power stored in the energy storing element from being fed back to the input end from the output end, wherein the energy storing element serves both a charging purpose and a discharging purpose; and connecting the core circuit set to an irregular power supply detecting unit, wherein the irregular power supply detecting unit is configured to detect the supplying state of the power and send, upon detection of interruption of the power, a control signal to the core circuit set so as for the core circuit set to execute the temporary process.

Compared with the prior art, the present invention enables a core circuit set of a circuit system to execute a temporary process during an unexpected interruption of power which should otherwise be supplied to the circuit system by a power supply, and ensure that the core circuit set will perform a shutdown preparation operation until completion thereof without causing a loss of or damage to a process being executed in the circuit system. According to the prior art, an increase in the number of peripheral non-core circuit sets necessitates an increase in the capacitance of a capacitor of a storage unit. By contrast, the present invention discloses supplying the minimal operating power required for operation of a core circuit set. Accordingly, the present invention dispenses with the high-capacitance capacitor required for operation of a conventional circuit system. As a result, a circuit system having a standby power supply unit and the circuit system layout method provided by the present invention are effective in providing low power consumption, a minimal-operation circuit, and an advantage, that is, completing, upon an unexpected interruption of power supply to the circuit system, a normal shutdown preparation operation which is otherwise impossible to start due to the power interruption.

### BRIEF DESCRIPTION OF THE DRAWINGS

A detailed description of further features and advantages of the present invention is given below so that a person skilled in the art can understand and implement the technical contents of the present invention and readily comprehend the objectives, features, and advantages thereof by reviewing the disclosure of the present specification and the appended claims in conjunction with the accompanying drawings, in which:

FIG. 1 is a block diagram of a circuit system having a standby power supply unit in a first embodiment of the present invention;

FIG. 2 is a block diagram of the circuit system having the standby power supply unit during power interruption in the first embodiment of the present invention;

FIG. 3 is a block diagram of a circuit system having a standby power supply unit in a second embodiment of the present invention;

FIG. 4 is a flow chart of a circuit system layout method in a third embodiment of the present invention; and

FIG. 5 is a schematic view of operation of the standby power supply unit of the circuit system shown in FIG. 1.

### DETAILED DESCRIPTION

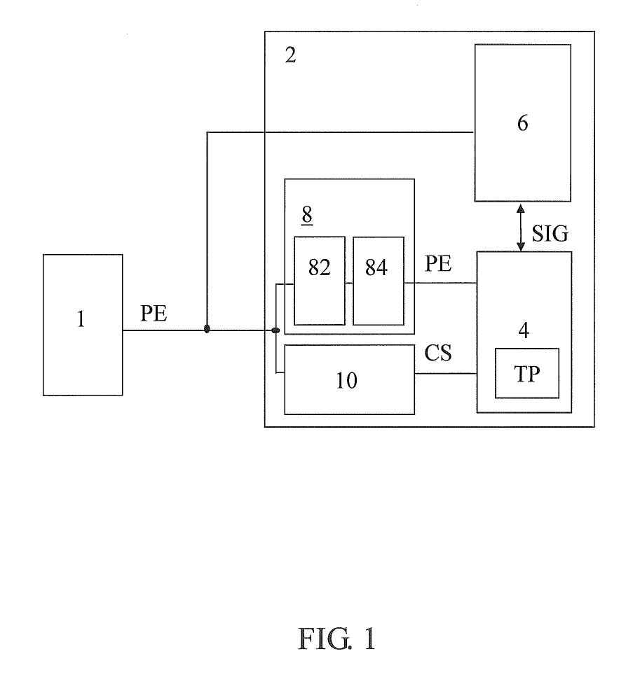

Referring to FIG. 1, there is shown a block diagram of a circuit system 2 having a standby power supply unit 8 in a first embodiment of the present invention. As shown in the drawing, the circuit system 2 operates on power PE supplied by a power source 1. For example, the power source 1 is a power supply capable of generating power or outputting converted power, a battery, or a secondary battery.

The circuit system 2 comprises a core circuit set 4, a non-core circuit set 6, the standby power supply unit 8, and an irregular power supply detecting unit 10. The core circuit set 4 is preloaded with a temporary process TP. The temporary process TP entails performing preparatory tasks that have to be completed before the circuit system 2 is shut down. Examples of the preparatory tasks include storing files in use or storing a pre-shutdown usage state of the circuit system 2. The core circuit set 4 is defined as an assembly required for the circuit system 2 to execute the temporary process TP. For example, the core circuit set 4 includes at least one of a memory, a flash memory, a microprocessor, and a network module. In practice, depending on their applicable fields, the circuit systems have different said temporary processes TP for protecting their important functions; hence, a core circuit set can have different assemblies accordingly. For example, a network-oriented electronic device usually has a circuit system with a core circuit set that includes a network module such that, during a power interruption, the network-related functionality of the network-oriented electronic device can be protected by the network module while the temporary process TP is being executed by the core circuit set.

The non-core circuit set 6 is connected to the power source 1 for receiving the power PE; as a result, the non-core circuit set 6 operates independently. The non-core circuit set 6 is an assembly that is required while execution of the temporary process TP is not underway. For example, the non-core circuit set 6 is a radio frequency (RF) circuit, a universal subscriber identity module (USIM), a global positioning system (GPS), a field programmable gate array (FPGA), and/or a complex programmable logic device (CPLD). In short, after a core circuit set in the circuit system has been defined, the remaining assemblies collectively function as a non-core circuit set.

Signals SIG are transmitted between the core circuit set 4 and the non-core circuit set 6 by means of a bus.

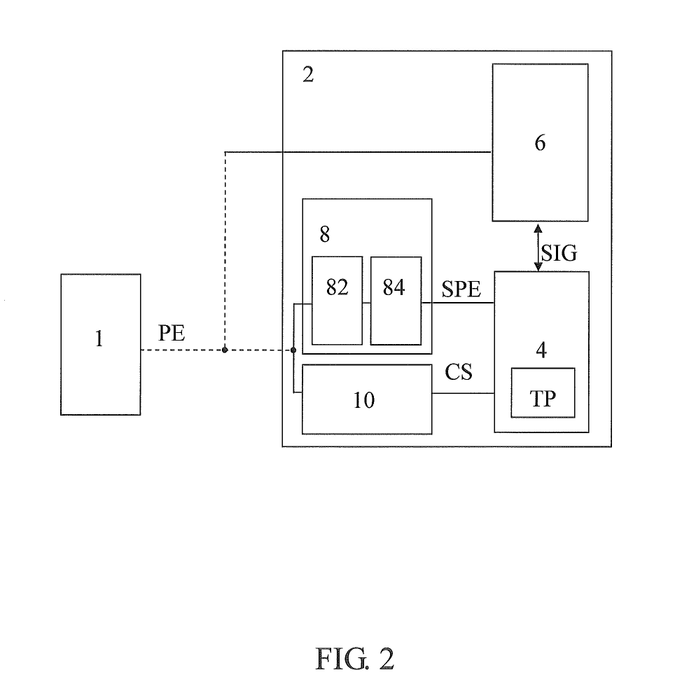

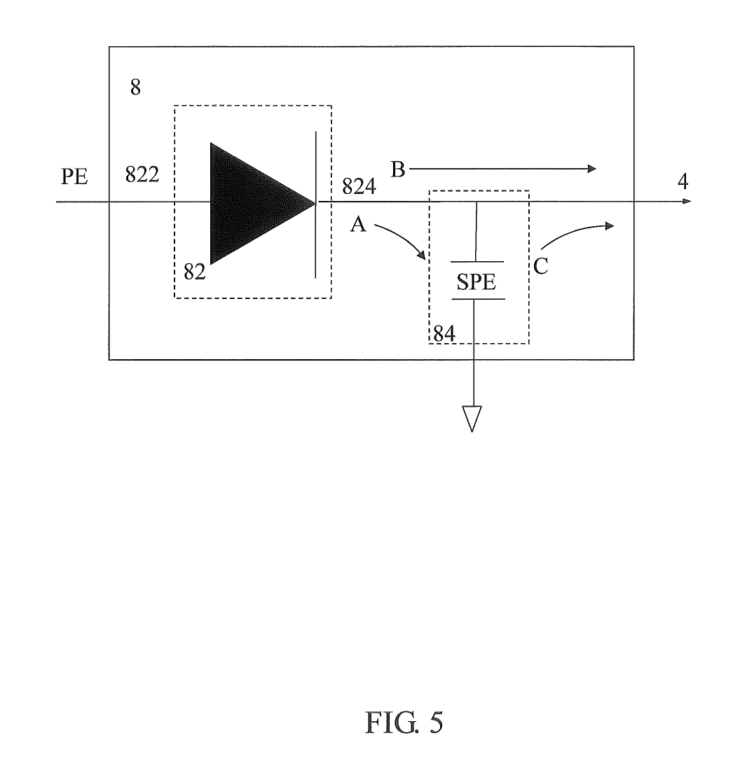

The standby power supply unit 8 comprises a one-way element 82 and an energy storing element 84. The one-way element 82 has an input end 822 and an output end 824. The input end 822 is connected to the power source 1. The output end 824 is connected to the core circuit set 4 and the energy storing element 84 simultaneously. The one-way element 82 prevents stored-power SPE stored in the energy storing element 84 from being fed back to the input end 822 from the output end 824 through the one-way element 82. The energy storing element 84 serves both a charging purpose and a discharging purpose. For example, the one-way element 82 is a diode or a transistor, whereas the energy storing element 84 is a capacitor or a secondary battery. Referring to FIG. 5, where the one-way element 82 is exemplified by a diode and the energy storing element 84 by a capacitor, the energy storing element 84 is charged with the power PE through the one-way element 82 and a charging path A so as for the stored-power SPE to be stored in the energy storing element 84. Also, the power PE is directly supplied to the core circuit set 4 through a power supplying path B. Once the power PE is no longer available, the stored-power SPE stored in the energy storing element 84 will be discharged and supplied to the core circuit set 4 through a discharging path C. The one-way element 82 prevents the stored-power SPE stored in the energy storing element 84 from being fed back to the output end 822 from the output end 824 and thereby prevents the stored-power SPE from being consumed by the non-core circuit set 6. Once the power PE is no longer supplied to the core circuit set 4, the stored-power SPE of the energy storing element 84 is continuously supplied to the core circuit set 4, as shown in FIG. 2. Likewise, the non-core circuit set 6 stops operating when receiving no power supply as soon as the power source 1 stops supplying the power PE.

The irregular power supply detecting unit 10 is connected to the core circuit set 4 and configured to detect the supplying state of the power PE. Upon interruption of supply of the power PE, the irregular power supply detecting unit 10 generates a control signal CS and sends the control signal CS to the core circuit set 4, thereby enabling the core circuit set 4 to execute the temporary process TP.

In conclusion, once the power source 1 stops supplying the power PE, the energy storing element 84 will begin supplying the stored-power SPE to the core circuit set 4; meanwhile, the irregular power supply detecting unit 10 generates the control signal CS and sends the control signal CS to the core circuit set 4, thereby enabling the core circuit set 4 to execute the temporary process TP. In other words, the core circuit set 4 operates on the stored-power SPE supplied by the energy storing element 84 so as to execute the temporary process TP.

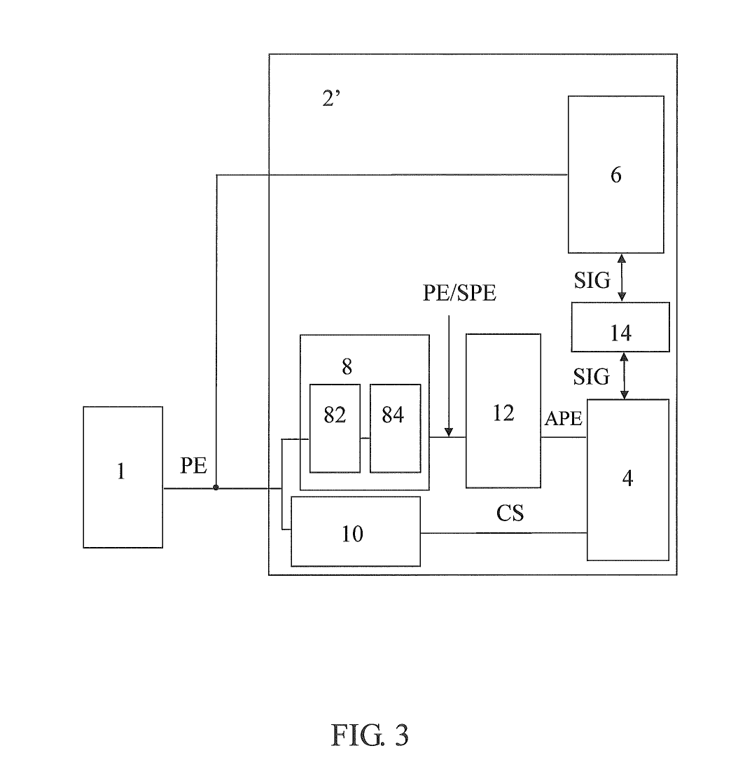

Referring to FIG. 3, there is shown a block diagram of a circuit system 2′ having a standby power supply unit in a second embodiment of the present invention. As shown in the drawing, the circuit system 2′ not only has the core circuit set 4, the non-core circuit set 6, the standby power supply unit 8, and the irregular power supply detecting unit 10 disclosed in the first embodiment, but also has a voltage adjusting unit 12 and a signal isolating unit 14. The voltage adjusting unit 12 is disposed between the output end 824 of the one-way element 82 and the core circuit set 4. The voltage adjusting unit 12 adjusts the power PE outputted from the output end 824 or the stored-power SPE such that, as a result of the adjustment, the power PE or the stored-power SPE is converted into adjusted-power APE. Then, the voltage adjusting unit 12 sends the adjusted-power APE to the core circuit set 4. The signal isolating unit 14 is disposed between the core circuit set 4 and the non-core circuit set 6 and configured to cut off the transmission of a signal SIG between the core circuit set 4 and the non-core circuit set 6 as soon as power interruption happens. In so doing, the operation of the core circuit set 4 is not affected by the electric potential of the non-core circuit set 6.

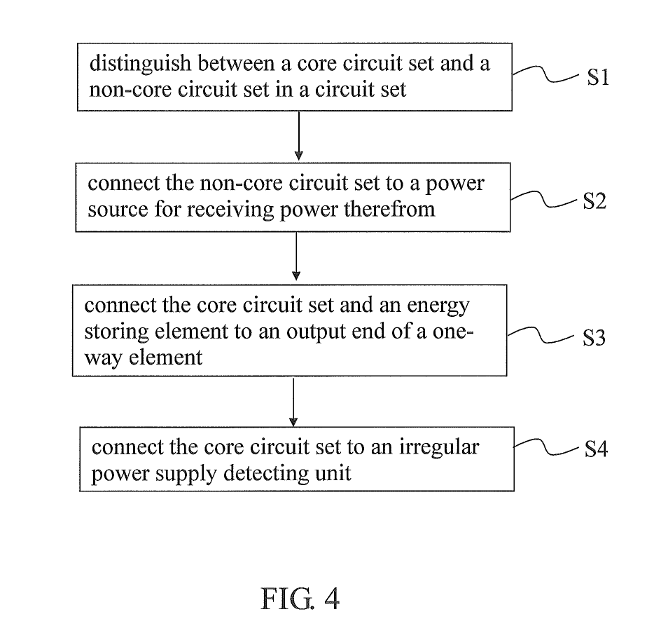

Referring to FIG. 4, there is shown a flow chart of a circuit system layout method in a third embodiment of the present invention. As shown in FIG. 4, the circuit system layout method is configured for use with a circuit system having a standby power supply unit and operating on power supplied by a power source. The circuit system layout method comprises the steps below. Step S1 involves distinguishing between a core circuit set and a non-core circuit set in a circuit set, wherein the core circuit set is preloaded with a temporary process. Step S2 involves connecting the non-core circuit set to the power source for receiving power therefrom. Step S3 involves connecting the core circuit set and an energy storing element to an output end of a one-way element, wherein the energy storing element and the one-way element collectively function as the standby power supply unit, and an input end of the one-way element connects with the power source and prevents stored-power stored in the energy storing element from being fed back to the input end from the output end, wherein the energy storing element serves both a charging purpose and a discharging purpose. Step S4 involves connecting the core circuit set to an irregular power supply detecting unit, wherein the irregular power supply detecting unit is configured to detect the supplying state of the power and send, upon detection of interruption of the power, a control signal to the core circuit set so as for the core circuit set to execute the temporary process.

A point to note is that, in the aforesaid steps, with the one-way element of the standby power supply unit, either the power from the power source is supplied to a power-storing element of the standby power supply unit in a one-way manner, or the power source supplies power to the core circuit set in a one-way manner.

The circuit system layout method further comprises the step of disposing a signal isolating unit between the core circuit set and the non-core circuit set for cutting off transmission of a signal therebetween, and the step of disposing a voltage adjusting unit between the output end of the one-way element and the core circuit set for adjusting the power outputted from the output end or the stored-power such that, as a result of the adjustment, the power or the stored-power is converted into adjusted-power, followed by sending the adjusted-power to the core circuit set.

Compared with the prior art, the present invention enables a core circuit set of a circuit system to execute a temporary process during an unexpected interruption of power which should otherwise be supplied to the circuit system by a power supply, and ensure that the core circuit set will perform a shutdown preparation operation until completion thereof without causing a loss of or damage to a process being executed in the circuit system. According to the prior art, an increase in the number of peripheral non-core circuit sets necessitates an increase in the capacitance of a capacitor of a storage unit. By contrast, the present invention discloses supplying the minimal operating power required for operation of a core circuit set. Accordingly, the present invention dispenses with the high-capacitance capacitor required for operation of a conventional circuit system. As a result, a circuit system having a standby power supply unit and the circuit system layout method provided by the present invention are effective in providing low power consumption, a minimal-operation circuit, and an advantage, that is, completing, upon an unexpected interruption of power supply to the circuit system, a normal shutdown preparation operation which is otherwise impossible to start due to the power interruption.

The foregoing embodiments are provided to illustrate and disclose the technical features of the present invention so as to enable persons skilled in the art to understand the disclosure of the present invention and implement the present invention accordingly, and are not intended to be restrictive of the scope of the present invention. Hence, all equivalent modifications and replacements made to the foregoing embodiments without departing from the spirit and principles in the disclosure of the present invention should fall within the scope of the present invention as set forth in the appended claims.

What is claimed is:

1. A circuit system having a standby power supply unit and operating on power supplied by a power source, the circuit system comprising:
a core circuit set preloaded with a temporary process;
a non-core circuit set connected to the power source for receiving the power;
a standby power supply unit comprising a one-way element and an energy storing element, the one-way element having an input end for connection with the power source and an output end for connection with the core circuit set and the energy storing element, the one-way element preventing stored-power stored in the energy storing element from being fed back to the input end from the output end, and the energy storing element serving both a charging purpose and a discharging purpose; and
an irregular power supply detecting unit connected to the core circuit set, configured to detect a supplying state of the power, and configured to send, upon detection of interruption of the power, a control signal to the core circuit set so as for the core circuit set to execute the temporary process.

2. The circuit system of claim 1, further comprising a signal isolating unit disposed between the core circuit set and the non-core circuit set and configured to cut off transmission of a signal between the core circuit set and the non-core circuit set.

3. The circuit system of claim 1, further comprising a voltage adjusting unit disposed between the output end of the one-way element and the core circuit set and configured to adjust the power outputted from the output end or the stored-power such that, as a result of the adjustment, the power or the stored-power is converted into adjusted-power output, wherein the adjusted-power is sent to the core circuit set.

4. The circuit system of claim 1, wherein the one-way element is a diode or a transistor, and the energy storing element is a capacitor or a secondary battery.

5. The circuit system of claim 1, wherein the core circuit set is at least one selected from the group consisting of a memory, a flash memory, a microprocessor, and a network module.

6. The circuit system of claim 1, wherein the non-core circuit set is at least one selected from the group consisting of a radio frequency (RF) circuit, a universal subscriber identity module (USIM), a global positioning system (GPS), a field programmable gate array (FPGA), and a complex programmable logic device (CPLD).

7. A circuit system layout method configured for use with a circuit system having a standby power supply unit and operating on power supplied by a power source, the circuit system layout method comprising the steps of:
distinguishing between a core circuit set and a non-core circuit set in a circuit set, wherein the core circuit set is preloaded with a temporary process;
connecting the non-core circuit set to the power source for receiving the power therefrom;
connecting the core circuit set and an energy storing element to an output end of a one-way element, wherein the energy storing element and the one-way element collectively function as the standby power supply unit, and an input end of the one-way element connects with the power source and prevents stored-power stored in the energy storing element from being fed back to the input end from the output end, wherein the energy storing element serves both a charging purpose and a discharging purpose; and
connecting the core circuit set to an irregular power supply detecting unit, wherein the irregular power supply detecting unit is configured to detect the supplying state of the power and send, upon detection of interruption of the power, a control signal to the core circuit set so as for the core circuit set to execute the temporary process.

8. The circuit system layout method of claim 7, further comprising the step of:
disposing a signal isolating unit between the core circuit set and the non-core circuit set for cutting off transmission of a signal therebetween.

9. The circuit system layout method of claim 7, further comprising the step of:
disposing a voltage adjusting unit between the output end of the one-way element and the core circuit set for adjusting the power outputted from the output end or the stored-power such that, as a result of the adjustment, the power or the stored-power is converted into adjusted-power, followed by sending the adjusted-power to the core circuit set.
